(19) United States
(12) Patent Application Publication
(10) Pub. No.: US 2004/0219507 A1
(43) Pub. Date: Nov. 4, 2004

(54) Apparatus for and methods of preparing sperm

(76) Inventor: Farhang Abed, Fahternheim Hospita (IR)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/481,536

(22) PCT Filed: Jun. 18, 2002
(86) PCT No.: PCT/GB02/02793

(30) Foreign Application Priority Data
Jun. 20, 2001 (GB) 0115105.9
Nov. 3, 2001 (GB) 0126593.3

(51) Int. Cl. A01N 1/02

(52) U.S. Cl. 435/2; 435/284.1

(57) ABSTRACT

A device (12) for separating motile sperm from a sperm-containing sample of semen comprises a tubular conduit (14) with a constrictor (20) therein. The constrictor is dimensioned to establish capillary flow of fluid therethrough. The sample is deposited in the larger cross-section upstream end (16) of the device, together with a fluid medium which entrains the semen through the constriction. The motile sperm, having passed through the constriction, swim against the flow and collect in a harvesting zone at the distal end of the conduit, from where they can be aspirated. Non-motile sperm are flushed from the device.

This invention relates generally to fertility, and more particularly to apparatus for and methods of preparing sperm for intracytoplasmic sperm injection (ICSI).

### BACKGROUND OF THE INVENTION

The introduction of ICSI which involves the direct injection of a sperm into an oocyte has bypassed the natural selection mechanisms for the fertilizing sperm. When performing ICSI a population of sperm are selected from the raw semen, using various methods of preparation. This population should have an increased proportion of motile sperm with normal morphology. However, it is not clear from the hundreds of sperm being observed which one is best qualified for injection.

Sperm preparation for ICSI uses the same conventional methods that are used for IVF, including “Percol” density gradient and “Swim up” methods. These methods can involve either centrifugation or the use of chemicals. It has been shown that centrifugal force generates the production of reactive oxygen species that may damage sperm and impair their fertilization potential. (R. J. Aitken and J. S. Clarkson “Cellular basis of defective sperm function and its association with the genesis of reactive oxygen species by human spermatozoa,” J. Reprod. Fertil. 1991; 6: pages 173-176). However, “Percol” has been used largely in the setting of laboratory research and its clinical use is associated with certain disadvantages. Some batches have been found to contain high levels of endotoxin, making them unsuitable for clinical use. In late 1996, “Percol” was withdrawn from clinical use as a sperm separation medium (Guneet Makkar, Hung-Yu Ng, et al. “Comparison of two colloidal silica-based sperm separation media with a non-silica-based medium,” Fertil. Steril. 1999; 72: pages 796-802.

It has been reported that when sperm are put into a fluid flow, the motile sperm rapidly align themselves and swim against the flow (F. Abed. “The new finding of a phenomenon in sperm motility: the spermatozoa swims against flow”—from “In vitro fertilization and assisted reproduction”, edited by V. Gomel and P. C. K. Leung, Monduzzi Editore, 1997: pages 13-15). Non-motile and sluggish sperm, along with other cellular components, are washed downstream away from the motile sperm. Cilia have been shown to be present in endometrial cells of many mammals. Ciliary currents in both the fallopian tubes and the uterus move in the same direction and extend towards the external os. One may expect that this flow performs two functions. Firstly, this flow acts as a guide for sperm, leading sperm with the correct motility parameters towards the site of fertilization at the ampoule of the fallopian tubes. Secondly, this flow acts as a natural selection mechanism to optimize the quality of sperm able to reach the fertilization site.

In U.S. Pat. No. 4,326,026 there is described a number of fractionating columns in which one establishes laminar flow. Nutrient is pumped into vertical pipettes and when the laminar flow has been established sperm is injected from a syringe. The sperm is then distributed evenly throughout the columns and samples can be withdrawn at different levels.

U.S. Pat. No. 4,759,344 describes a rudimentary arrangement for separating motile sperm from semen. There is however no means of establishing a flow of fluid and nor is there any constriction which would produce a capillary flow.

U.S. Pat. No. 5,296,375 describes devices and methods for clinical analysis of sperm samples. The devices have an inlet port and a flow channel which is referred to as a mesoscale flow channel.

U.S. Pat. No. 5,686,302 shows a sperm separating device in which a fluid bridge is created through which the sperm can pass, but no fluid flow is established.

### SUMMARY OF THE INVENTION

It is an object of the present invention to use sperm alignment against fluid flow to separate motile, morphologically normal sperm suitable for ICSI from semen. In addition, the method and apparatus of the present invention have several advantages over conventional methods:

the present invention utilizes the sperm alignment against flow phenomenon;

it does not induce any damage to sperm, because the procedure does not require any centrifugation or chemicals;

it is rapid and simple;

the process of sperm separation is under direct observation and can be easily controlled. Other methods tend to be blind and there is little or no control while performing the process and it is not until the end of the process that the quality of sperm can be evaluated.

In accordance with one aspect of the present invention there is provided a sperm separation device comprising a tubular conduit defining an upstream zone for receiving semen and a downstream zone from which sperm are arranged to be harvested, the upstream and downstream zones being separated by constriction means within the conduit, the constriction means being arranged to establish capillary flow of a fluid medium from the upstream zone to the downstream zone, whereby motile sperm in semen inserted into the conduit upstream from the constriction means and subjected to the flow of the fluid medium are enabled, having passed through the constriction means, to maintain a position in the downstream zone for harvesting.

The conduit preferably has a relatively large upstream end and a relatively small downstream end.

Preferably, the constriction means comprises means within the conduit defining a substantially hour-glass-shaped passageway for the sperm and fluid. The constriction means is preferably provided adjacent to the downstream end of the conduit.

Also in accordance with the present invention there is provided a method of separating sperm, which comprises inserting sperm-containing semen into a tubular conduit upstream from constriction means within the conduit which is arranged to create capillary flow therethrough, filling the conduit upstream from the constriction means with fluid, thereby to cause flow of semen and fluid through the constriction means, and harvesting motile sperm from the downstream side of the constriction means.

Preferably, the population of motile sperm is aspirated from the conduit using a pipette.

Preferably, the tubular conduit is made of glass which is not reactive with the semen or fluid medium.

### BRIEF DESCRIPTION OF THE DRAWINGS

A more detailed description of the present invention will now be given, with reference to the accompanying drawings, wherein like reference characters refer to like parts throughout the several views, and in which:

FIG. 1 is a schematic diagram of one embodiment of a sperm separation device in accordance with the invention placed on a microscope slide;

FIG. 2 is a schematic view, on an enlarged scale, of the distal end of the device shown in FIG. 1 and illustrating the use of a pipette for aspirating the motile sperm;

FIG. 3 is a schematic illustration of a second embodiment of sperm separation device in accordance with the present invention; and

FIG. 4 is a schematic view, on an enlarged scale, of the distal end of the device shown in FIG. 3 and illustrating the use of a pipette for aspirating the motile sperm.

### DETAILED DESCRIPTION OF THE PREFERRED EMBODIMENT

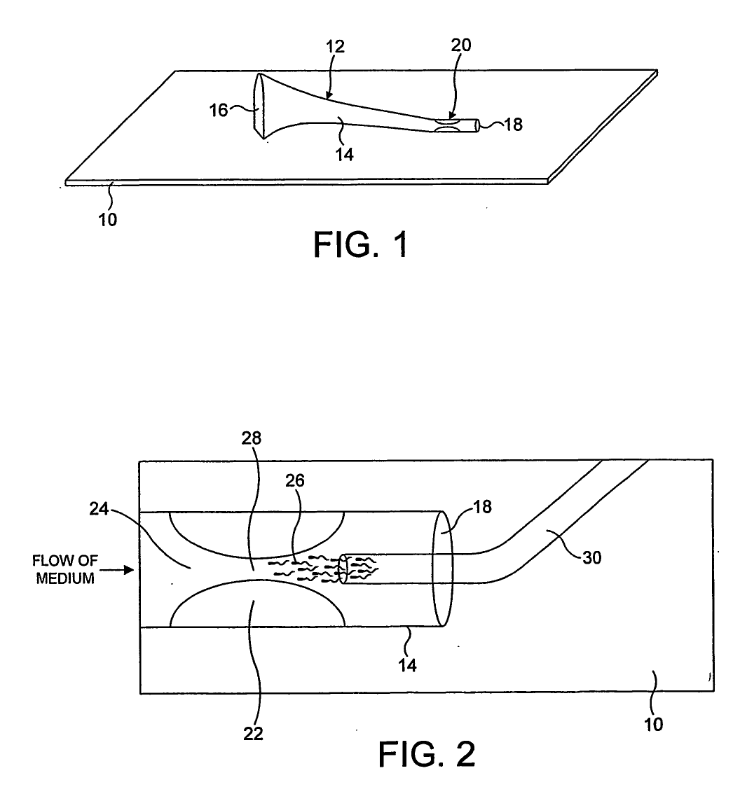

Referring first to the embodiment shown in FIGS. 1 and 2, FIG. 1 shows a microscope slide 10 on which is positioned a sperm separation device 12 in accordance with the invention. The device comprises a glass tube 14 which has a relatively large inlet end 16 and a relatively small outlet or distal end 18. Within the tube 14, adjacent to the distal end 18, there is provided a constriction 20. The tube 14 is funnel-shaped from the inlet 16 to the constriction 20 and is cylindrical in shape from the constriction 20 to the outlet end 18. The inlet end 16 of the tube is substantially semicircular in shape, with a flat edge resting on the slide 10.

The constriction 20 comprises a convex protuberance 22 within and encircling the conduit. This defines a tapering upstream zone 24, a tapering downstream zone 26 and a short central zone 28 which is substantially cylindrical.

FIG. 2 shows the end of a micro-pipette 30 inserted into the distal end of the conduit and with its mouth positioned adjacent to the downstream zone 26.

Preferably, the tube 14 and the micro-pipette 30 are made of glass, whereas the microscope slide 10 can be made of glass or plastics material.

In order to perform the sperm preparation procedure, the tubular conduit 12 is first placed on the slide 10. Approximately 3 μl of semen is placed, using a needle, into the tapering upstream zone 24 of the constriction 20. The upstream end of the tube 14 is then filled with a warm fluid medium, through the inlet end 16. This fluid medium will flow through the constriction 20 towards the distal end 18 as a capillary flow. The semen is carried through the constriction by the flow of fluid. After for example 2 minutes, if the tapering downstream zone 26 of the constriction is observed under an inverted microscope, it will be seen that there is an accumulation of sperm in the tapering downstream zone 26. These are motile sperm which have passed through the constriction and which are swimming against the flow of the medium, maintaining their position within the downstream zone of the constriction. It will be seen that the number of these motile sperm gradually increases with time. The seminal plasma, non-motile and sluggish sperm, other cellular components and bacteria pass on from zone 26 and out through the distal end 18 of the tube. The active, motile sperm swim against the flow, and form a population at the downstream zone 26.

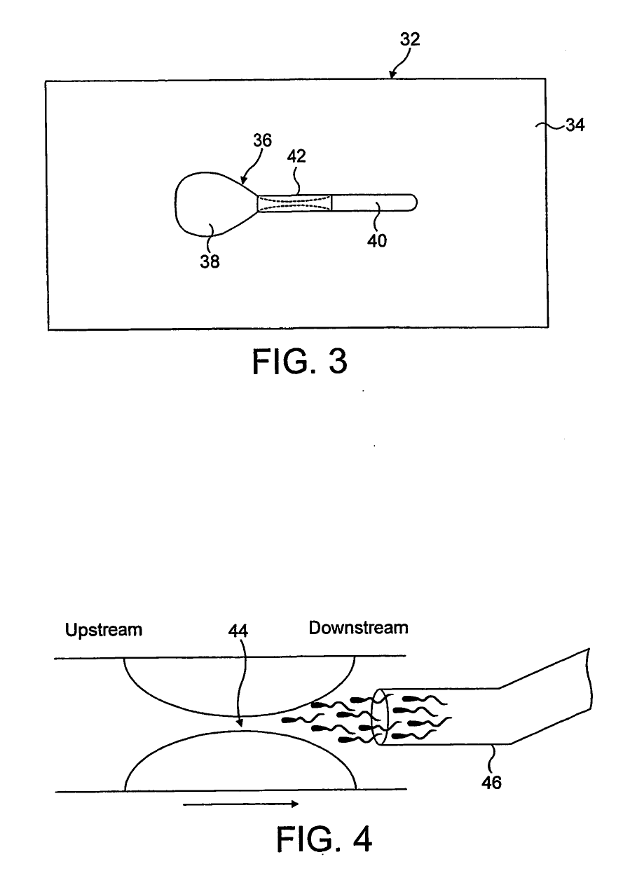

Referring now to FIG. 3, a thin plate 32 is shown, preferably of plastics material, in the upper surface 34 of which there is formed a recess indicated generally at 36. This recess comprises a well 38 which at one end leads into an elongate groove 40. Between the well 38 and the groove 40 is inserted a piece of capillary tube 42. The piece of capillary tube 42 is shaped internally like an hourglass, in order to provide a constriction 44 to the flow of fluid therethrough. The piece of capillary tube 42 can be composed of an upstream conical segment and a downstream conical segment joined by a short intermediate segment. This means that one has a tapering upstream zone, a tapering downstream zone and a short central zone which is substantially cylindrical.

FIG. 4 shows the end of a micropipette 46 inserted into the distal end of the capillary tube 42 and with its mouth positioned in the downstream zone.

The plate 32 and the capillary tube 42 can be made of glass or plastics material, although it is preferred that the plate is made of plastics material and the capillary tube of glass.

In one practical example, approximately 3 μl of semen was placed, using a needle, into the upstream conical segment of the capillary tube 42. The well 38 was then filled with 50 μl of warm Ham's F-10 medium. The medium entered the capillary tube 42 and flowed through the hourglass constriction 44. After 2 minutes the tapering downstream segment was observed under an inverted microscope, using a high power field. It was observed that good numbers of sperm had accumulated inside the downstream conical segment, i.e the harvesting zone. They were swimming against the flow of medium and their numbers gradually increased with time. Using the micropipette 46, this population of sperm was aspirated and evaluated.

In both embodiments, the velocity of the fluid flowing through the narrowest portion of the constriction can be changed by changing the dimensions of the narrowest portion of the constriction. Increasing the diameter of this constriction will reduce the velocity, and vice versa. It is arranged that the dimensions of the constriction, and the viscosity of the fluid medium, are such that there is a velocity of flow of the medium through the constriction which enables motile sperm just to keep pace with the medium which exits the waist of the hourglass-shaped constriction. Using the micro-pipette, this population of sperm can be aspirated. In this way it is easy to recover an adequate number of motile, morphologically normal sperm suitable for ICSI.

With the present invention, only the most qualified sperm are selected, and the device only permits sperm that are capable of moving faster than the flow of fluid to reach the harvesting zone at the distal end of the tube. The seminal plasma and non-motile sperm are flushed from the tube.

1. A sperm separation device, comprising a tubular conduit defining an upstream zone for receiving semen and a downstream zone from which sperm are arranged to be harvested, the upstream and downstream zones being separated by constriction means within the conduit, the constriction means being arranged to establish capillary flow of a fluid medium from the upstream zone to the downstream zone, whereby motile sperm in semen inserted into the conduit upstream from the constriction means and subjected to the flow of the fluid medium are enabled, having passed through the constriction means, to maintain a position in the downstream zone for harvesting.

2. A device according to claim 1, wherein the conduit has an upstream end of relatively large cross-section, and a downstream end of relatively small cross-section.

3. A device according to claim 1, wherein the constriction means defines a substantially hour-glass-shaped passageway within the conduit.

4. A device according to claim 1, wherein the constriction means is provided adjacent to the downstream end of the conduit.

5. A device according to claim 1, wherein the conduit is of plastics material.

6. A device according to claim 1, wherein the conduit is made of glass.

7. A device according to claim 1, wherein the conduit is supported on a baseplate.

8. A device according to claim 7, wherein the upstream zone and the downstream zone are defined by recesses in the baseplate.

9. A device according to claim 8, wherein the upstream zone is defined by a well and the downstream zone is defined by an elongate groove.

10. A device according to claim 1, wherein the conduit has a substantially cylindrical cross-section.

11. A device according to claim 1, wherein the conduit has a substantially semi-circular cross-section.

12. A device apparatus according to claim 11, wherein the upstream zone of the conduit is substantially funnel-shaped from the upstream end of the conduit to the constriction means.

13. A method of separating sperm, which comprises inserting sperm-containing semen into a tubular conduit upstream from constriction means within the conduit which is arranged to create capillary flow therethrough, filling the conduit upstream from the constriction means with fluid, thereby to cause flow of semen and fluid through the constriction means, and harvesting motile sperm from the downstream side of the constriction means.

14. A method according to claim 13, in which the population of motile sperm is aspirated from the conduit using a pipette.

15. A kit of parts comprising a sperm separation device as claimed in claim 1 and a pipette for harvesting motile sperm.
